(19) United States
(12) Patent Application Publication
(10) Pub. No.: US 2018/0352827 A1
(43) Pub. Date: Dec. 13, 2018

(54) FAT COMPOSITION FOR LOW-TRANS FAT, NON-TEMPERED CHOCOLATE AND CHOCOLATE

(71) Applicant: FUJI OIL HOLDINGS INC., Osaka (JP)

(72) Inventor: Makoto TOGASHI, Kaizuka-shi, Osaka (JP)

(73) Assignee: FUJI OIL HOLDINGS INC., Osaka (JP)

(21) Appl. No.: 15/781,267

(22) PCT Filed: Mar. 9, 2017
(86) PCT No.: PCT/JP2017/009448

§ 371 Date: Jun. 4, 2018

(30) Foreign Application Priority Data
Mar. 31, 2016 (JP) 2016-070009

(51) Int. Cl. A23D 9/013; A23G 1/36

(52) U.S. Cl. CPC A23D 9/013; A23V 2002/00; A23G 1/36

(57) ABSTRACT

The purpose of the present invention is to provide, as fat for non-tempered chocolate, a fat composition which can contain less trans fats and more cacao materials such as cocoa butter and cocoa mass, and has good melting and snapping properties. The present invention is accomplished on the basis of a finding that a transesterified fat having a specific fatty acid composition is effective against the problem as well as knowledge that a combination of the fat composition with a specific emulsifier is effective for the problem. The present invention provides fat for chocolate and chocolate which has a strong chocolate flavor and good melting and snapping properties such that health risks linked to trans fats can be avoided.

### TECHNICAL FIELD

The present invention relates to a fat composition for chocolate and a chocolate product using the same.

### BACKGROUND ART

In general, chocolate is produced by mixing ingredients such as cacao mass, cocoa, cocoa butter, saccharide, and milk powder, and subjecting the mixture to refining, conching and tempering treatment. This tempering process is an operation of lowering the temperature of the chocolate dough once and then heating it again. This is difficult operation requiring sufficient knowledge, experience and skill, as well as special apparatus in chocolate factory.

Meanwhile, non-tempering fat, such as lauric non-tempering fat and trans non-tempering fat, is known as a fat which does not require a complicated tempering treatment. Lauric non-tempering fat derived from coconut oil, palm kernel oil, fractionated oil or extremely hydrogenated oil thereof shows excellent snappiness. However, bloom may occur when chocolate is prepared by mixing 5% by weight or more of cocoa butter and lauric non-tempering fat. Thus, there is a problem that only a chocolate having poor cacao flavor is prepared from lauric non-tempering fat because sufficient amount of cacao mass including cocoa butter cannot be blended. Trans non-tempering fat derived from hardened fat prepared by hydrogenation has high compatibility with cocoa butter, about 20% by weight. Thus, trans non-tempering fat is hard to cause bloom occurrence when cacao mass is blended. However, trans non-tempering fat may contain 40 to 50% by weight of trans fatty acid. Recently, however, it is shown that a risk of developing heart disease increases by ingesting trans fatty acid, and thus, it is mainstream to reduce the contents of trans fatty acid.

A trans fatty acid free interesterified fat for chocolate is known, and it is prepared by interesterifying fat such as palm oil, palm fractionated oil, coconut oil, and palm kernel oil chemically or with enzyme. However, such an interesterified fat shows relatively low compatibility with cacao butter. Thus, there is a problem that only a chocolate having poor flavor is prepared from said fat because high amount of cacao ingredient such as cacao mass cannot be blended.

Patent Document 1 describes a random transesterified fat derived from oil containing 2 to 50% by weight of saturated fatty acid having 14 or less carbon atoms and 1 to 50% by weight of saturated fatty acid having 20 or more carbon atoms. Patent Document 2 describes a transesterified oil composition containing 50 to 95% of palm oil as a main raw material, 0.1% or more and less than 25% of saturated fatty acid having 12 carbon atoms and 50 to 70% of saturated fatty acid having 14 to 22 carbon atoms. Although these have low trans fatty acid content, these are plastic fats for baked confectionery such as pie and biscuit. Thus, these are not suitable for chocolate coating which is required to have suitable hardness and sufficient meltability in the mouth. Patent Document 3 describes a fat composition for chocolate, which is transesterified fat without containing trans fatty acid and is excellent in compatibility with cocoa butter and meltability in the mouth. However, compatibility with cocoa butter and meltability in the mouth are still insufficient, and a solution of the problem has been desired.

### PRIOR ART DOCUMENTS

### Patent Document

Patent Document 1: JP H09-165595 A

Patent Document 2: JP 2012-070655 A

Patent Document 3: WO 2007/129590 A1

### SUMMARY OF INVENTION

### Problems to Be Solved by Invention

An object of the present invention is to provide a fat composition for non-tempering chocolate, which contains low amount of trans fatty acid, which may be blended with a large amount of cacao raw material such as cocoa butter and cacao mass, and which may provide a chocolate having excellent meltability in the mouth and snappiness.

### Means for Solving Problems

The inventor has extensively studied for solving the above problems. As a result, the inventor has found that an interesterified fat of fat having specific fatty acid composition is effective for the above problems, and that a combination of this fat and specific emulsifier is effective for the above problems. The present invention has been completed based on these findings.

That is, the first aspect of the present invention is a fat composition for chocolate, containing an interesterified fat containing 5 to 15% by weight of fatty acid having 10 or less carbon atoms, 35 to 55% by weight of fatty acid having 14 or less carbon atoms, and 2 to 12% by weight of fatty acid having 20 or more carbon atoms, as constituent fatty acids, where an iodine value of the fat composition is 5 to 15, and where a trans fatty acid content of the fat composition is 2% by weight or less.

The second aspect of the present invention is the fat composition for chocolate of the first aspect, further containing sorbitan fatty acid ester and/or sucrose fatty acid ester.

The third aspect of the present invention is a chocolate product containing the fat composition of the first or second aspect.

The fourth aspect of the present invention is the chocolate product of the third aspect, containing 20 to 60% by weight of the fat composition with respect to total weight of the chocolate.

### Effect of Invention

The present invention enables to provide a chocolate product having a strong chocolate flavor, excellent meltability in the mouth and snappiness, and avoiding health risk of trans fatty acid, and a fat composition for the chocolate.

### Mode for Carrying Out Invention

As used herein, triglyceride constituting fat is one in which three molecules of fatty acids are esterified to one molecule of glycerol.

As used herein, chocolate product is not limited to the chocolate in the “Fair Competition Convention on the Show Kind of Chocolate” defined by Fair Trade Commission of chocolate industry, but includes a processed fat food obtained by using raw materials, such as sugar, milk powder and edible fat, regardless of including cacao component or not.

A fat composition for chocolate of the present invention contains 5 to 15% by weight, preferably 7 to 13% by weight of fatty acid having 10 or less carbon atoms. In addition, the fat composition contains 35 to 55% by weight, preferably 40 to 50% by weight of fatty acid having 14 or less carbon atoms. Further, the fat composition contains 2 to 12% by weight, preferably 3 to 10% by weight, of fatty acid having 20 or more carbon atoms.

When a content of the fatty acid having 10 or less carbon atoms exceeds the upper limit, the snappiness tends to be inferior. When it is less than the lower limit, the bloom resistance tends to be inferior. When a content of the fatty acid having 14 or less carbon atoms exceeds the upper limit, the bloom resistance tends to be inferior. When it is less than the lower limit, it may be undesirable from the viewpoint of meltability in the mouth. When a content of the fatty acid having 20 or more carbon atoms exceeds the upper limit, the meltability in the mouth tends to be inferior. When it is less than the lower limit, the bloom resistance and heat resistance may be inferior.

The fat composition for chocolate of the present invention has 5 to 15 of iodine value and 2% by weight or less of trans fatty acid content.

Examples of raw material of the fat composition of the present invention include vegetable fat such as soybean oil, rapeseed oil, high-erucic rapeseed oil, sunflower seed oil, cottonseed oil, peanut oil, rice bran oil, corn oil, safflower oil, olive oil, kapok oil, sesame oil, evening primrose oil, palm oil, palm kernel oil, coconut oil, cocoa butter, shea butter, sal fat, and illipe butter; animal fat such as beef tallow, and lard; and synthetic oil such as MCT (Medium Chain Triglyceride fat); single fat or mixed fat thereof; and processed fat thereof (including fat subjected to hydrogenation, fractionation, interesterification, or any combinations thereof). Among them, MCT is preferably used as a fat rich in fatty acid having 10 or less carbon number. Palm kernel oil, coconut oil, or processed fat thereof is preferably used as a fat rich in fatty acid having 14 or less carbon number. High-erucic rapeseed oil, or processed fat thereof, most preferably extreme hydrogenated high-erucic rapeseed oil, is preferably used as a fat rich in fatty acid having 20 or more carbon number.

A method for interesterification includes a method in which fatty acids bound to 1-position and 3-position of a triglyceride is specifically exchanged using an enzyme (1, 3-position specific interesterification), and a method of randomly exchanging regardless of the binding position of fatty acid by using an enzyme or a metal catalyst (for example, sodium methylate) (random interesterification). The random interesterification is preferred in the present invention because this is more effective for suppressing coarsening of symmetric triglycerides by generating more complicated fat crystals, and it is preferable from the viewpoint of enhancing compatibility with cocoa butter.

A fat composition for chocolate of the present invention may contain sorbitan fatty acid ester and/or sucrose fatty acid ester. A sorbitan fatty acid ester is a fatty acid ester in which fatty acid is bound to hydroxyl group of sorbitan or sorbitol. As the fatty acid, a long chain saturated fatty acid having 16 or more carbon atoms such as stearic acid and palmitic acid is preferable. A sucrose fatty acid ester is a fatty acid ester in which fatty acid is bound to hydroxyl group of sucrose. As the fatty acid, a long chain saturated fatty acid having 16 or more carbon atoms such as stearic acid and palmitic acid is preferable. The sucrose fatty acid ester also includes acetylated sucrose fatty acid ester of which hydroxyl group is substituted with acetyl group. Both the sorbitan fatty acid ester and the sucrose fatty acid ester preferably have HLB of 0 to 8. The addition amount is preferably from 0.1 to 5.0% as an addition amount to the fat composition, more preferably 2.0% by weight or less from the viewpoint of cost effectiveness.

The fat composition for chocolate of the present invention may contain fat other than the above mentioned interesterified fat as long as the fat does not impair the effect of the present invention. For example, it is preferable because chocolate containing fat having 45° C. or more of melting point may show improved solidification speed. Examples of fat having 45° C. or more of melting point include extremely hydrogenated oil of high-erucic rapeseed oil, extremely hydrogenated palm oil, and extremely hydrogenated rapeseed oil. A content of the fat having 45° C. or more of melting point is not particularly limited, but usually less than 10% by weight, preferably less than 5% by weight, more preferably less than 3% by weight, as the total amount, based on the total weight of the fat composition.

The fat composition for chocolate of the present invention preferably has 10 or less of SFC at 35° C. If it exceeds this upper limit, it may result in very bad meltability in the mouth. The fat composition also preferably has 50 or more of SFC at 20° C. If it is less than this lower limit, sufficient snappiness may not be obtained.

The chocolate product of the present invention is preferably contains the fat composition in an amount of 20 to 60% by weight, more preferably 25 to 50% by weight, based on the whole chocolate product. The fat composition of the present invention may be used alone or in combination with other fats. In the present invention, sorbitan fatty acid ester or sucrose fatty acid ester is preferably added to the fat composition, but it may also be added at the time of producing chocolate.

### EXAMPLES

Hereinafter, the effects of the present invention will be clarified by exemplifying examples, but the spirit of the present invention is not limited to the following examples. In the examples, % and part are weight basis.

### Example 1

Mixture of 57 parts of coconut oil, 30 parts of fractionated palm stearin, 10 parts of extremely hydrogenated high-erucic rapeseed oil, and 3 parts of medium chain triglyceride fat (product name: MCT-64, Fuji Oil Co., Ltd.) was interesterified, and the obtained fat was refined according to a conventional method to obtain the fat composition of Example 1. Iodine value of the fat composition was 9.6 and trans fatty acid content of the fat composition was 2.0% by weight or less.

### Example 2

Mixture of 30 parts of coconut oil, 25 parts of hydrogenated coconut oil, 27 parts of fractionated palm stearin, 15 parts of extremely hydrogenated high-erucic rapeseed oil, and 3 parts of medium chain triglyceride fat was interesterified, and the obtained fat was refined according to a conventional method to obtain the fat composition of Example 2. Iodine value of the fat composition was 11.3 and trans fatty acid content of the fat composition was 2.0% by weight or less.

### Example 3

Mixture of 55 parts of coconut oil, 30 parts of fractionated palm stearin, 10 parts of extremely hydrogenated high-erucic rapeseed oil, and 5 parts of medium chain triglyceride fat was interesterified, and the obtained fat was refined according to a conventional method to obtain the fat composition of Example 3. Iodine value of the fat composition was 8.4 and trans fatty acid content of the fat composition was 2.0% by weight or less.

### Example 4

Mixture of 57 parts of coconut oil, 30 parts of fractionated palm stearin, 5 parts of extremely hydrogenated palm oil, 8 parts of extremely hydrogenated high-erucic rapeseed oil, and 5 parts of medium chain triglyceride fat was interesterified, and the obtained fat was refined according to a conventional method to obtain the fat composition of Example 4. Iodine value of the fat composition was 8.5 and trans fatty acid content of the fat composition was 2.0% by weight or less.

### Example 5

The fat composition of Example 5 was prepared by mixing 2.0 parts of sorbitan fatty acid ester (Poem S-65V, manufactured by Riken Vitamin Co., Ltd, HLB: 3.0) to 100 parts of the fat composition of Example 1.

### Example 6

The fat composition of Example 6 was prepared by mixing 2.0 parts of acetylated sucrose fatty acid ester (DK ester FA10E, manufactured by Dai-ichi Kogyo Seiyaku Co., Ltd.) to 100 parts of the fat composition of Example 1.

The fatty acid compositions (%) of the fat compositions of Examples 1 to 4 were summarized in Table 1. Measurement was carried out according to Standard methods for the analysis of fats, oils and related materials.

TABLE 1
Fatty acid compositions of fat compositions of Examples 1-4

| | C8 | C10 | C12 | C14 | C16 | C18 | C18:1 | C18:2 | C20 | C22 |
|---|---|---|---|---|---|---|---|---|---|---|
| Fat | 4.6 | 4.0 | 25.5 | 10.4 | 31.3 | 7.5 | 8.0 | 1.8 | 1.2 | 5.6 |
| composition of | | | | | | | | | | |
| Example 1 | | | | | | | | | | |
| Fat | 4.5 | 3.8 | 24.4 | 10.1 | 24.0 | 11.7 | 9.4 | 2.0 | 1.7 | 8.4 |
| composition of | | | | | | | | | | |
| Example 2 | | | | | | | | | | |
| Fat | 5.2 | 4.5 | 24.5 | 10.0 | 32.8 | 7.7 | 7.0 | 1.6 | 1.3 | 5.5 |
| composition of | | | | | | | | | | |
| Example 3 | | | | | | | | | | |
| Fat | 5.1 | 4.5 | 25.4 | 10.6 | 33.2 | 6.8 | 7.2 | 1.6 | 1.0 | 4.5 |
| composition of | | | | | | | | | | |
| Example 4 | | | | | | | | | | |

### Comparative Example 1

Mixture of 51 parts of palm kernel oil, 39 parts of fractionated palm stearin, and 10 parts of extremely hydrogenated high-erucic rapeseed oil was interesterified, and the obtained fat was refined according to a conventional method to obtain the fat composition of Comparative Example 1. Iodine value of the obtained fat was 14.4 and trans fatty acid content of the obtained fat was 2.0% by weight or less.

### Comparative Example 2

Mixture of 40 parts of coconut oil, 40 parts of fractionated palm stearin, and 20 parts of extremely hydrogenated high-erucic rapeseed oil was interesterified, and the obtained fat was refined according to a conventional method to obtain the fat composition of Comparative Example 2.

### Comparative Example 3

Mixture of 50 parts of coconut oil, 30 parts of fractionated palm stearin, and 20 parts of extremely hydrogenated high-erucic rapeseed oil was interesterified, and the obtained fat was refined according to a conventional method to obtain the fat composition of Comparative Example 3.

### Comparative Example 4

Mixture of 40 parts of hydrogenated coconut oil, 30 parts of fractionated palm stearin, 15 parts of extremely hydrogenated high-erucic rapeseed oil, and 15 parts of medium chain triglyceride fat was interesterified, and the obtained fat was refined according to a conventional method to obtain the fat composition of Comparative Example 4.

### Comparative Example 5

Mixture of 50 parts of coconut oil, 40 parts of fractionated palm stearin, and 10 parts of extremely hydrogenated high-erucic rapeseed oil was interesterified, and the obtained fat was refined according to a conventional method to obtain the fat composition of Comparative Example 5.

The fatty acid compositions (%) of the fat compositions of Comparative Examples 1 to 5 were summarized in Table 2. Measurement was carried out according to Standard methods for the analysis of fats, oils and related materials.

TABLE 2
Fatty acid compositions of fat compositions of Comparative Examples 1-5

| | C8 | C10 | C12 | C14 | C16 | C18 | C18:1 | C18:2 | C20 | C22 |
|---|---|---|---|---|---|---|---|---|---|---|
| Fat | 0.6 | 1.1 | 25.8 | 11.3 | 32.1 | 7.5 | 12.6 | 2.3 | 1.2 | 5.2 |
| composition of | | | | | | | | | | |
| Comparative | | | | | | | | | | |
| Example 1 | | | | | | | | | | |
| Fat | 2.3 | 2.1 | 17.7 | 7.5 | 30.7 | 11.4 | 12.9 | 2.7 | 2.2 | 10.2 |
| composition of | | | | | | | | | | |
| Comparative | | | | | | | | | | |
| Example 2 | | | | | | | | | | |
| Fat | 3.0 | 2.7 | 22.5 | 9.2 | 25.1 | 11.2 | 11.0 | 2.4 | 2.1 | 10.3 |
| composition of | | | | | | | | | | |
| Comparative | | | | | | | | | | |
| Example 3 | | | | | | | | | | |
| Fat | 8.2 | 7.4 | 18.5 | 7.9 | 25.3 | 12.8 | 8.1 | 1.7 | 1.7 | 8.1 |
| composition of | | | | | | | | | | |
| Comparative | | | | | | | | | | |
| Example 4 | | | | | | | | | | |
| Fat | 3.0 | 2.6 | 22.8 | 9.6 | 29.9 | 7.7 | 14.6 | 3.2 | 1.3 | 5.2 |
| composition of | | | | | | | | | | |
| Comparative | | | | | | | | | | |
| Example 5 | | | | | | | | | | |

For the fat compositions of Examples 1 to 4 and Comparative Examples 1 to 5, total amount of fatty acid having 10 or less carbon atoms (% by weight), total amount of fatty acid having 14 or less carbon atoms (% by weight), total amount of fatty acid having 20 or more carbon atoms (% by weight), iodine value, and trans fatty acid content were summarized in table 3. For Reference Examples, lauric non-tempering fat, “Palkena H” (manufactured by Fuji Oil Co., Ltd.) and trans non-tempering fat, “Melano H1000” (manufactured by Fuji Oil Co., Ltd.) were summarized in table 3.

TABLE 3
Total content of each fatty acid (% by weight)

| | C10 or | C14 or | C20 or | | Trans fatty |
|---|---|---|---|---|---|
| | less | less | more | Iodine | acid |
| | total | total | total | value | content |
| Fat composition | 8.6 | 44.5 | 6.8 | 9.6 | 2.0 or less |
| of Example 1 | | | | | |
| Fat composition | 8.3 | 42.8 | 10.1 | 11.3 | 2.0 or less |
| of Example 2 | | | | | |
| Fat composition | 9.7 | 44.2 | 6.8 | 8.4 | 2.0 or less |
| of Example 3 | | | | | |
| Fat composition | 9.6 | 45.6 | 5.5 | 8.5 | 2.0 or less |
| of Example 4 | | | | | |
| Fat composition | 1.7 | 38.8 | 6.4 | 14.4 | 2.0 or less |
| of Comparative | | | | | |
| Example 1 | | | | | |
| Fat composition | 4.4 | 29.6 | 12.4 | 15.9 | 2.0 or less |
| of Comparative | | | | | |
| Example 2 | | | | | |
| Fat composition | 5.7 | 37.4 | 12.4 | 13.7 | 2.0 or less |
| of Comparative | | | | | |
| Example 3 | | | | | |
| Fat composition | 15.6 | 42.0 | 9.8 | 9.7 | 2.0 or less |
| of Comparative | | | | | |
| Example 4 | | | | | |
| Fat composition | 5.6 | 38.0 | 6.5 | 18.1 | 2.0 or less |
| of Comparative | | | | | |
| Example 5 | | | | | |
| Palkena H | 4.3 | 81.3 | 0.0 | 0.5 | 2.0 or less |
| Melano H1000 | 0.0 | 1.3 | 0.0 | 55.0 | 41.0 |

SFCs of the fat compositions of Examples 1 to 4 and Comparative Examples 1 to 5 were summarized in Table 4. Measurement was carried out according to Standard methods for the analysis of fats, oils and related materials.

TABLE 4
SFCs of fat compositions of Examples 1 to 4 and
Comparative Examples 1 to 5

| | SEC (%) | | | | |
|---|---|---|---|---|---|
| | 10° C. | 20° C. | 25° C. | 30° C. | 35° C. |
| Fat composition of | 84 | 60 | 43 | 23 | 6 |
| Example 1 | | | | | |
| Fat composition of | 83 | 58 | 40 | 21 | 7 |
| Example 2 | | | | | |
| Fat composition of | 83 | 59 | 41 | 23 | 7 |
| Example 3 | | | | | |
| Fat composition of | 84 | 58 | 40 | 21 | 5 |
| Example 4 | | | | | |
| Fat composition of | 95 | 80 | 64 | 42 | 17 |
| Comparative Example 1 | | | | | |
| Fat composition of | 89 | 69 | 54 | 37 | 21 |
| Comparative Example 2 | | | | | |
| Fat composition of | 87 | 65 | 49 | 29 | 13 |
| Comparative Example 3 | | | | | |
| Fat composition of | 69 | 42 | 26 | 13 | 4 |
| Comparative Example 4 | | | | | |
| Fat composition of | 84 | 58 | 41 | 23 | 8 |
| Comparative Example 5 | | | | | |

### (Preparation of Chocolate)

Chocolates of Examples 1A to 6A and Comparative Examples 1A to 5A were prepared by using the fat compositions of Examples 1 to 6 and Comparative Examples 1 to 5, respectively, as raw materials, according to a conventional method. The formulation is shown in Table 5.

TABLE 5
Formulation of chocolate

| | |
|---|---|
| Cocoa powder | 19.4 parts by weight |
| Sugar | 30.0 parts by weight |
| Whole fat milk powder | 14.0 parts by weight |
| Cocoa butter | 5.5 parts by weight |
| Fat composition of Examples | 31.1 parts by weight |
| or Comparative Examples | |
| Lecithin | 0.4 part by weight |

### (Sensory Evaluation and Storage Test of Chocolate)

The produced chocolate was poured into mold and cooled to solidify. Meltability in the mouth and snappiness were evaluated as sensory evaluation. In addition, chocolate of each Example and Comparative Example was subjected to storage test by placing in an incubator at constant temperature of 20° C. or at temperature cycle of 17 to 28° C. Incidentally, the temperature cycle of 17 to 28° C. was at 17° C. for 10 hours, at elevated temperature from 17 to 28° C. for 2 hours, at 28° C. for 10 hours, and decreased temperature from 28 to 17° C. for 2 hours as 1 cycle for 24 hours. As an evaluation of the storage test, presence or absence of bloom occurrence after 1 month was confirmed. The results are summarized in Table 6.

TABLE 6
Result of sensory evaluation and storage test of
chocolate

| | Sensory evaluation | | | |
|---|---|---|---|---|
| | Meltability | | Storage test evaluation | |
| | in the mouth | Snappiness | 20° C. | 17 to 28° C. |
| Example 1A | ⊚ | ⊚ | ⊚ | ⊚ |
| Example 2A | ⊚ | ◯ | ⊚ | ⊚ |
| Example 3A | ◯ | ⊚ | ◯ | ⊚ |
| Example 4A | ◯ | ⊚ | ◯ | ⊚ |
| Example 5A | ⊚ | ⊚ | ⊚ | ⊚ |
| Example 6A | ⊚ | ⊚ | ⊚ | ⊚ |
| Comparative | X | ⊚ | X | Not conducted |
| Example 1A | | | | |
| Comparative | X | ⊚ | Not conducted | Not conducted |
| Example 2A | | | | |
| Comparative | X | ⊚ | Not conducted | Not conducted |
| Example 3A | | | | |
| Comparative | ◯ | X | Not conducted | Not conducted |
| Example 4A | | | | |
| Comparative | X | ⊚ | ⊚ | ⊚ |
| Example 5A | | | | |

Evaluation criteria
Meltability in the mouth: ⊚: excellent, ◯: good, X: poor meltability
Snappiness: ⊚: excellent, ◯: good, X: poor snappiness
Bloom: ⊚: no bloom occurrence, ◯: no gloss, X: bloom occurrence

As a result, all of Examples 1A to 6A had good meltability in the mouth and snappiness, and showed no bloom occurrence in the storage test. However, Comparative Examples 1A to 5A showed inferior result in at least any one of meltability in the mouth, snappiness, and bloom occurrence. That is, the fat compositions of Examples 1 to 6 were chocolate fats containing no trans fatty acid, being capable of blending higher amount of cocoa butter, and having better meltability in the mouth and snappiness.

### (Storage Test at Various Cocoa Butter Contents)

Chocolates were prepared in various cocoa butter contents in the same manner as described above by using the fat compositions of Example 1 and Comparative Example 1, and a sensory test and a storage test at 20° C. were carried out. The results are shown in Tables 7 and 8 below. Evaluation criteria are based on Table 6.

TABLE 7
Result of sensory evaluation

| | | Sensory evaluation | |
|---|---|---|---|
| | Cocoa butter | Meltability in | |
| | content | the mouth | Snappiness |
| Fat composition of | 8% by weight | ∘ | ∘ |
| Example 1 | 11% by weight | ∘ | ∘ |
| | 15% by weight | ∘ | ∘ |
| | 18% by weight | ∘ | ∘ |
| Fat composition of | 8% by weight | x | ∘ |
| Comparative Example 1 | 11% by weight | x | ∘ |
| | 15% by weight | x | ∘ |
| | 18% by weight | x | ∘ |

TABLE 8
Result of storage test

| | | Storage test period at 20° C. | | | | |
|---|---|---|---|---|---|---|
| | Cocoa butter | 14 | 28 | 2 | 3 | 4 |
| | content | days | days | months | months | months |
| Fat com- | 8% by weight | ∘ | ∘ | ∘ | ∘ | ∘ |
| position of | 11% by weight | ∘ | ∘ | ∘ | ∘ | ∘ |
| Example 1 | 15% by weight | ∘ | ∘ | ∘ | x | x |
| | 18% by weight | ∘ | ∘ | x | x | x |
| Fat com- | 8% by weight | ∘ | ∘ | ∘ | ∘ | ∘ |
| position of | 11% by weight | ∘ | ∘ | x | x | x |
| Comparative | 15% by weight | ∘ | x | x | x | x |
| Example 1 | 18% by weight | x | x | x | x | x |

The results showed that chocolate prepared by using the fat composition of Example 1 had good meltability in the mouth and snappiness at all cocoa butter contents. However, the chocolate prepared by using the fat composition of Comparative Example 1 had snappiness but poor meltability in the mouth.

The results of the storage test showed that the bloom occurrence became faster as the cocoa butter content increased in the chocolate prepared by using the fat composition of Comparative Example 1. However, the chocolate prepared by using the fat composition of Example 1 showed obviously slower bloom occurrence than that of Comparative Example 1, and showed no bloom occurrence after 4 months storage at 11% by weight of cocoa butter content.

Further, the chocolate prepared by using the fat composition of Example 1 at 11% by weight of cocoa butter content, which showed no bloom occurrence after 4 months storage, showed remarkably improved meltability in the mouth as compared with the chocolate prepared by using the fat composition of Comparative Example 1 at 11% by weight of cocoa butter content.

1-4. (canceled)

5. A fat composition for chocolate, comprising an interesterified fat comprising 7 to 15% by weight of fatty acid having 10 or less carbon atoms, 35 to 55% by weight of fatty acid having 14 or less carbon atoms, and 2 to 12% by weight of fatty acid having 20 or more carbon atoms, as constituent fatty acids, wherein an iodine value of the fat composition is 5 to 11.3, and wherein a trans fatty acid content of the fat composition is 2% by weight or less.

6. The fat composition for chocolate according to claim 5, wherein a raw material of the interesterified fat comprises MCT (Medium Chain Triglyceride fat).

7. The fat composition for chocolate according to claim 5, further comprising sorbitan fatty acid ester and/or sucrose fatty acid ester.

8. A chocolate comprising the fat composition according to claim 5.

9. A chocolate comprising the fat composition according to claim 6.

10. A chocolate comprising the fat composition according to claim 7.

11. The chocolate according to claim 8, comprising 20 to 60% by weight of the fat composition with respect to total weight of the chocolate.

12. The chocolate according to claim 9, comprising 20 to 60% by weight of the fat composition with respect to total weight of the chocolate.

13. The chocolate according to claim 10, comprising 20 to 60% by weight of the fat composition with respect to total weight of the chocolate.
